(19) United States
(12) Patent Application Publication
(10) Pub. No.: US 2005/0088792 A1
(43) Pub. Date: Apr. 28, 2005

(54) Surge suppression apparatus including an LC neutral-ground filter

(76) Inventors: Bahram Mechanic, Houston, TX (US); Tooraj Faridi, Houston, TX (US)

Correspondence Address: ROBERT W STROZIER, P.L.L.C, PO BOX 429, BELLAIRE, TX, 77402-0429, US

(21) Appl. No.: 10/692,298

(22) Filed: Oct. 23, 2003

(51) Int. Cl. H02H 3/20

(52) U.S. Cl. 361/91.1

(57) ABSTRACT

A transient voltage surge suppressor apparatus is disclosed to protect equipment with voltage sensitive electronics, such as office equipment, from surges or transients in the power distribution network furnishing power, where apparatus includes an LC filter component between neutral and ground leads having at least on inductive element disposed in the ground lead and a capacitive component connected between the neutral and ground leads after the inductive element toward the device. The apparatus can also sense incoming voltage and electrically isolate components of the apparatus and/or disconnects the neutral leads and hot leads of the power network from the neutral lead and hot lead of the office equipment if a voltage surge above a threshold level as well as voltage suppression circuits and/or filters between hot and neutral and between hot and ground and voltage suppression circuits between neutral and ground.

### BACKGROUND OF THE INVENTION

1. Field of the Invention

The present invention relates to an electrical protective filter apparatus or transient voltage surge suppressor (TVSS) apparatus for protecting electrically powered devices from transient voltages such as office equipment or any microprocessor-based equipment.

More particularly, the present invention relates to an electrical protective filter apparatus or transient voltage surge suppressor (TVSS) apparatus for protecting electrically powered devices from transient voltages in a three-lead, single phase, power supply from a power distribution network, where the apparatus includes at least one LC filter circuit with the inductive component of the LC filter circuit disposed in the ground lead and the capacitive component between neutral and ground lead after the inductive component toward device and method for protecting such devices.

2. Description of the Related Art

Numerous types of office equipment used in recent years contain electronic chips or components which are sensitive to voltage surges or transients in power furnished by a power distribution network provided by utility companies. Examples of such types of office equipment include computers, facsimile machines, photocopiers and the like. Apparatus known as power filters or transient voltage surge suppressors have been developed to protect these types of office equipment from such power surges or transients. U.S. Pat. No. 5,721,661, of which applicant is inventor, is one form of such a power filter.

Office buildings and other places including such sensitive equipment often use a or center-tap power distribution system. There are several advantages of such distribution systems: (1) they allow more power to be delivered to a site, (2) they are more easily distributed, and (3) they allow two voltage levels (such as 120 volts and 240 volts) to be easily delivered. These advantages afford the customers greater flexibility in equipment type and usage and provide for a more cost effective way for an electric utility to transmit power to customers. In three phase or center tap power distribution system, if a ground wire or a neutral wire connection in the distribution grid is lost, voltage levels provided in the network may increase up to a double level. Such voltage increases are not uncommon and can result in 120 V rated equipment rated being subjected to up to 240 volts resulting in potential damage to a surge protection component, firing of the TVSS unit or direct damage to the electrical equipment.

So far as is known, it was typical to use relatively inexpensive thermal fuses for protective purposes in these situations. These fuses would typically open after response to excess heat for periods of from couple of seconds to several minutes. It may protect the TVSS against firing after burn out, but sensitive electronic chips and circuits of connected equipment were not capable of withstanding such excessive voltage levels for even short fractions of a second, such as a few milliseconds.

Although several surge protection devices are currently sold into the market that rely on power interruptions circuitry such as those described in U.S. Pat. Nos.: 6,229,682 and 6,560,086, incorporated herein by reference, there is still in the art for improved surge suppression apparatuses that will improve power supply to critical microprocessor-based equipment and simultaneously reduce the risk of transient voltage damage to the equipment. New digital equipment need more filtration between neutral and ground leads to function smoothly because of more complex and low operating voltage (2.3V) microprocessors and need noise between neutral and ground leads be below 0.5V.

### SUMMARY OF THE INVENTION

The present invention provides a new and improved protective apparatus for electrical devices connected to a three-lead, single phase power supply from a power distribution network, where the apparatus includes at least one neutral-ground LC filter circuit, where the inductive component (L) of the LC filter circuit is disposed in the ground lead and the capacitive component (C) is connected between the neutral and ground leads after the inductive component toward the device. The LC filter circuit is adapted to substantially reduce ground noise or noise between ground and neutral. By disposed in the ground lead, the inventors mean that the inductor is in series with the ground lead and not connected between ground and either of the other two leads.

The present invention also provides a new and improved protective apparatus for electrical devices connected to a three-lead, single phase power supply from a power distribution network, where the apparatus includes at least one neutral-ground LC filter circuit with the inductive component of the LC filter circuit disposed in the ground lead and the capacitive component connected between the neutral and ground leads after the inductive component toward the device and a plurality of protective circuits interposed between hot and neutral, hot and ground and neutral and ground leads.

The present invention also provides a protective circuit having hot, neutral, and ground leads arranged to be placed between corresponding utility hot, neutral and ground leads of a power utility outlet of a power distribution network and corresponding device hot, neutral and ground leads of at least one electrical and/or electronic device, the protective circuit including at least one LC filter including at least one inductor disposed in the circuit ground lead and at least one capacitor connected between the circuit neutral and ground leads after the inductor toward the device, where the at least one LC filter circuit component is adapted to reduce or eliminate ground noise or noise between ground and neutral leads transmitted to the devices. The protective circuit may optionally also include neutral-ground voltage surge protective components.

The present invention also provides a new and improved protective apparatus for electrical devices connected to a power distribution network, where the apparatus includes at least one neutral-ground LC filter circuit with the inductive component of the LC filter circuit disposed in the ground lead and at least one capacitive component connected between the circuit neutral and ground leads after the inductor toward the device. The apparatus can also include hot to neutral voltage surge protective components, hot to ground voltage surge protective components, and a neural to ground voltage surge protection/filtration components. The apparatus also includes a relay circuit R, a voltage threshold sensing circuit T and indicator circuits S1 and S2, where the relay circuit R is designed to protect components of the apparatus and/or to protect the electronic and/or electrical devices connected thereto or both from abnormal power conditions including over voltages, transients, loss of ground, polarity reversals or any other abnormal power supply condition. Although the threshold voltage can be set at any voltage over the standard supply voltage (120V US and 240V non-US), generally, the threshold voltage is set between about 10% and about 50% over standard supply voltage, preferably, between about 15% and about 30%, and particularly, between about 20% and about 25% above the standard supply voltage.

The present invention provides a method for protecting an electronic and/or electrical device connected to a three-lead, single phase power supply from a power distribution network including the step of interposing between an outlet of the network and the electronic and/or electrical device a protective apparatus of this invention.

### DESCRIPTION OF THE DRAWINGS

The invention can be better understood with reference to the following detailed description together with the appended illustrative drawings in which like elements are numbered the same:

FIG. 1A depicts a block schematic diagram of a preferred embodiment of a protective circuit apparatus of this invention;

FIG. 1B depicts a block schematic diagram of a preferred embodiment of a protective circuit apparatus of this invention including a UPS interposed between the protective circuit apparatus and a device;

FIG. 1C depicts a block schematic diagram of a preferred embodiment of a protective circuit apparatus of this invention including a UPS interposed between the protective circuit apparatus and a device with a capacitive component between neutral and ground interposed between the UPS and the device;

FIG. 2A depicts a schematic diagram of a preferred embodiment of a protective apparatus of this invention including an LC filter component to filter noise between neutral and ground;

FIG. 2B depicts a schematic diagram of a preferred embodiment of a protective apparatus of this invention which filters noise between neutral and ground leads and also including an LC filter component with an inductor in the hot lead to filter noise between hot and neutral and between hot and ground leads;

FIG. 2C depicts a schematic diagram of an alternate preferred embodiment of a protective apparatus of this invention which filters noise between neutral and ground leads and also including an LC filter component with an inductor disposed in the neutral lead to filter noise between hot and neutral and between hot and ground leads;

FIG. 2D depicts a schematic diagram of an alternate preferred embodiment of a protective apparatus of this invention which filters noise between neutral and ground leads and also including an LC filter component with an inductor in the hot lead and an inductor in the neutral lead to filter noise between hot and neutral and between hot and ground leads;

FIG. 2E depicts a schematic diagram of an alternate preferred embodiment of a protective apparatus of this invention including a plurality of sequentially connected LC filter components to filter noise between neutral and ground leads and also including an LC filter component with an inductor in the hot lead and/or an inductor in the neutral lead to filter noise between hot and neutral and between hot and ground leads; and

FIG. 3 depicts a schematic diagram of another preferred embodiment of a protective apparatus of this invention including a plurality of switches adapted to protect the electronic and/or electrical device and each of the protective circuit components including at least one LC filter having the inductive element disposed in the ground lead at a capacitive element between the neutral and ground leads after the inductive element toward the device.

### DETAILED DESCRIPTION OF THE INVENTION

The inventors have found that a surge suppression or TVSS apparatus can be constructed for protecting electronic and/or electrical device in a three-lead, single phase power supply from a power distribution network, where the apparatus includes at least one neutral-ground LC filter circuit, where the inductive element is disposed in the ground lead on the utility side of the capacitive component. The apparatus can also be constructed with a relay component to disconnect the capacitive component of the LC filter circuit in the event of an abnormality such as a loss of ground, reversal of hot and neutral leads, over voltage and any other similar abnormality in the provided power. The apparatus can also include a voltage threshold sensing component, indicator components and voltage surge protection/filtration components between hot and neutral and between hot and ground, and between neutral and ground, where the components act cooperatively to protect electronic and/or electrical devices attached thereto from transients and/or over voltages.

The present invention broadly relates to a surge suppression apparatus for protecting electronic and/or electrical device in a power distribution network including at least one neutral-ground LC filter circuit having the inductive element disposed in the ground lead and the capacitive component between the neutral and ground lead after the inductive component toward the device and where the LC filter circuit is adapted to substantially reduce or eliminate ground noise or noise between ground and neutral and when coupled with a relay circuit that can disconnect the capacitive component of the LC filter circuit, the apparatus also reduces ground leakage currents.

The present invention broadly relates to a method for protecting electronic and/or electrical device in a power distribution network including the step of installing an apparatus of this invention between an outlet in the network and an electronic and/or electrical device.

The present invention relates to a new and improved protective circuit or transient voltage suppressor for electrical and electronic and/or electrical devices. The protective apparatus includes at least one neutral-ground LC filter having the inductive component disposed in the ground lead and the capacitive component between the neutral and ground lead after the inductive component toward the device. The apparatus can also include other LC filters with the inductors in series with hot and/or neutral leads and capacitors between the hot and neutral leads and voltage surge protecting circuits and clamping devices such as MOV, gas tube, Transil, and Sidactor between any pair of leads. In one preferred embodiment, the present invention includes a differential transformer with one winding in series with circuit hot lead and one winding in series with the circuit neutral leads. The preferred embodiment of the electrical device may take the form of a computer, a copier, a facsimile machine or the like having voltage surge or transient sensitive electronic components, such as computer chips and other electrical component.

The apparatuses of this invention are designed to be interposed between an outlet of a distributed power network and electronic or electrical devices sensitive to abnormal power conditions. Such abnormal power conditions include, without limitation, over voltages, transient voltage spikes, disconnected ground leads, polarity reversals of hot and neutral leads, and other similar abnormalities that can result in damage to sensitive electronic or electrical devices and device components.

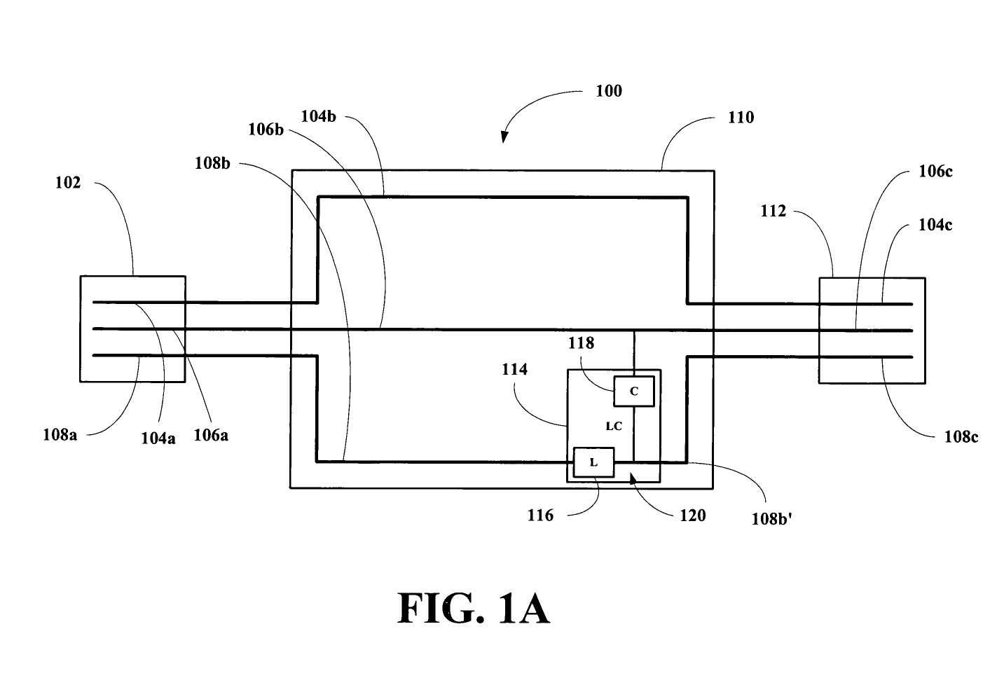

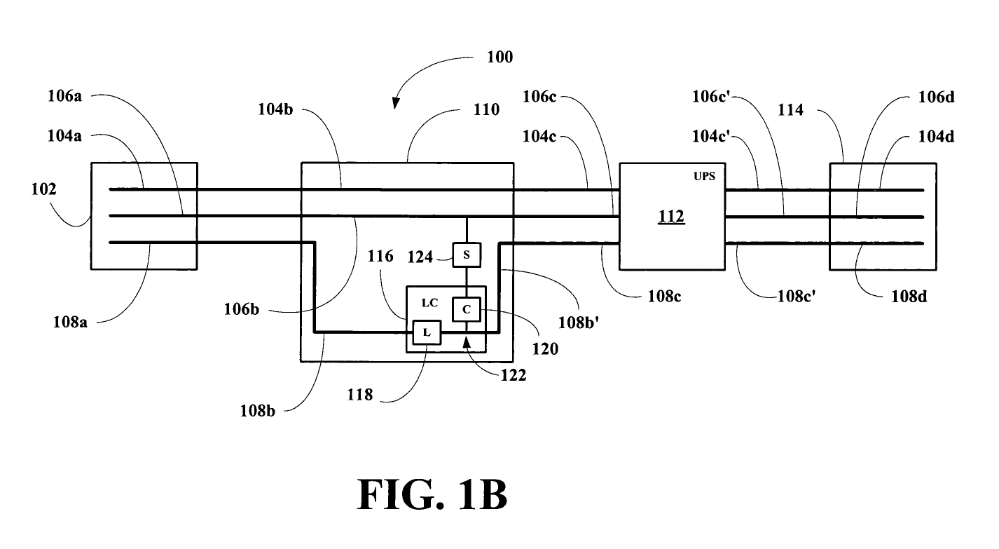

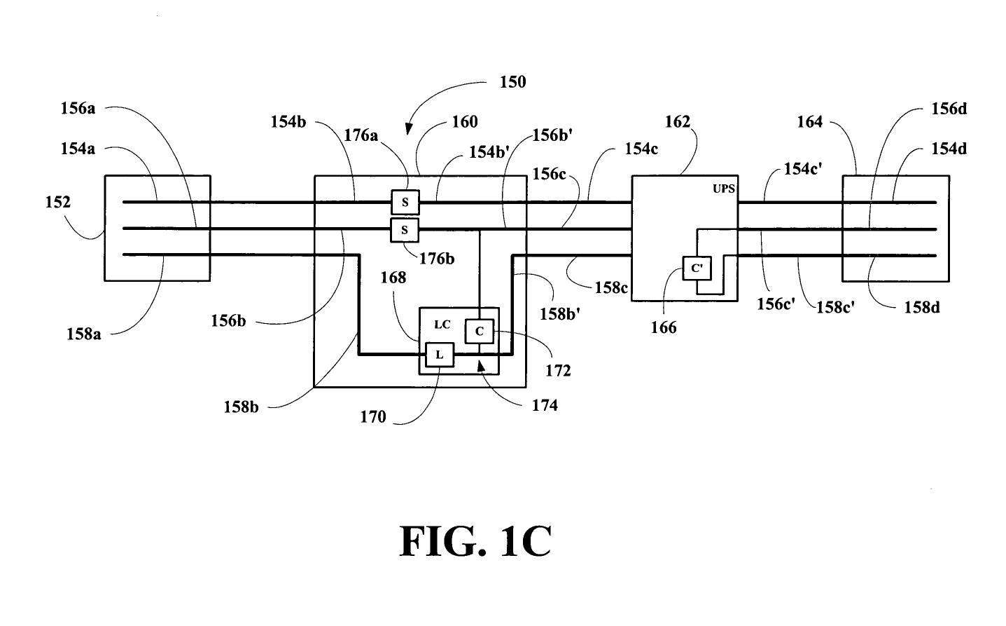

Referring now to FIG. 1A, a block schematic diagram of a preferred embodiment of an apparatus of our invention, generally 100, is shown to include a power distribution network outlet 102 having utility hot, neutral, and a ground leads 104a, 106a, and 108a, respectively. The apparatus 100 also includes a surge apparatus 110 having apparatus hot, neutral and ground leads 104b, 106b, and 108b, respectively, connected to the corresponding utility leads 104a, 106a, and 108a. The apparatus 110 is interposed between the utility outlet 102 and an electrical or electronic device 112 having device hot, neutral and ground leads 104c, 106c, and 108c, respectively, connected to the corresponding apparatus leads 104b, 106b, and 108b′, where the prime designation is used to indicate that lead has the inductive component 116 disposed in the ground lead. The apparatus 110 includes a neutral-ground LC filter circuit 114 having the inductive component 116 disposed in the apparatus ground lead 108b and the capacitive component 118 connected between the neutral and ground leads 106b and 108b′ and located on device side 120 of the inductive component 116. The LC filter 114 is designed to substantially reduce or eliminate neutral to ground noise transmitted to the device 112.

Looking at FIG. 1B, a block schematic diagram of another preferred embodiment of an apparatus of our invention integrated with an UPS device, generally 100, is shown to include a power distribution network outlet 102 having utility hot, neutral, and a ground leads 104a, 106a, and 108a, respectively. The apparatus 100 also includes an apparatus 110 having circuit hot, neutral and ground leads 104b, 106b, and 108b, respectively, connected to the corresponding utility leads 104a, 106a, and 108a. The apparatus 110 is interposed between the utility outlet 102 and an uninterruptible power supply (UPS) device 112 having UPS hot, neutral and ground leads 104c, 106c, and 108c, respectively, connected to the corresponding circuit leads 104b, 106b, and 108b′. The UPS device 112 is interposed between the apparatus 110 and an electrical or electronic device 114 having device hot, neutral and ground leads 104d, 106d, and 108d, respectively, connected to the corresponding UPS output leads 104c′, 106c′, and 108c′. The apparatus 110 includes a neutral-ground LC filter circuit 116 having the inductive component 118 disposed in the apparatus ground lead 108b and the capacitive component 120 connected between the neutral and ground leads 106b and 108b′ and located on device side 122 of the inductive component 118. The LC filter 116 also includes a relay switch 124 adapted to disconnect the capacitive component 120 if an abnormal condition exists in the supplied power. The LC filter 116 is designed to substantially reduce or eliminate neutral to ground noise transmitted to the electrical device 114. The UPS device 112 can be any UPS device used in the industry.

Looking at FIG. 1C, a block schematic diagram of another preferred embodiment of an apparatus of our invention integrated with an UPS device, generally 150, is shown to include a power distribution network outlet 152 having utility hot, neutral, and a ground leads 154a, 156a, and 158a, respectively. The apparatus 150 also includes an apparatus 160 having apparatus hot, neutral and ground leads 154b, 156b, and 158b, respectively, connected to the corresponding utility leads 154a, 156a, and 158a. The apparatus 160 is interposed between the utility outlet 152 and an UPS device 162 having UPS hot, neutral and ground leads 154c, 156c, and 158c, respectively, connected to the corresponding circuit leads 154b′, 156b′, and 158b′. The UPS device 162 is interposed between the apparatus 160 and an electrical or electronic device 164 having device hot, neutral and ground leads 154d, 156d, and 158d, respectively, connected to the corresponding UPS output leads 154c′, 156c′, and 158c′. The apparatus 150 also includes a capacitive component 166 between neutral and ground leads 156c′ and 158c′ on the output of the UPS device 162. The apparatus 160 includes a neutral-ground LC filter circuit 168 having an inductive component 170 disposed in the apparatus ground lead 158b and an optional capacitive component 172 connected between the neutral and ground leads 156b′ and 158b′ and located on device side 174 of the inductive component 170. The apparatus 160 also includes two relay switches 176a&b adapted to disconnect the hot and neutral leads 154b and 156b, respectively, if an abnormal condition exists in the supplied power. It should be recognized that the leads 154b′ and 156b′ are so designated because they are on the device side of the switches 176a&b. The LC filter 168 is designed to substantially reduce or eliminate neutral to ground noise transmitted to the electrical device 164.

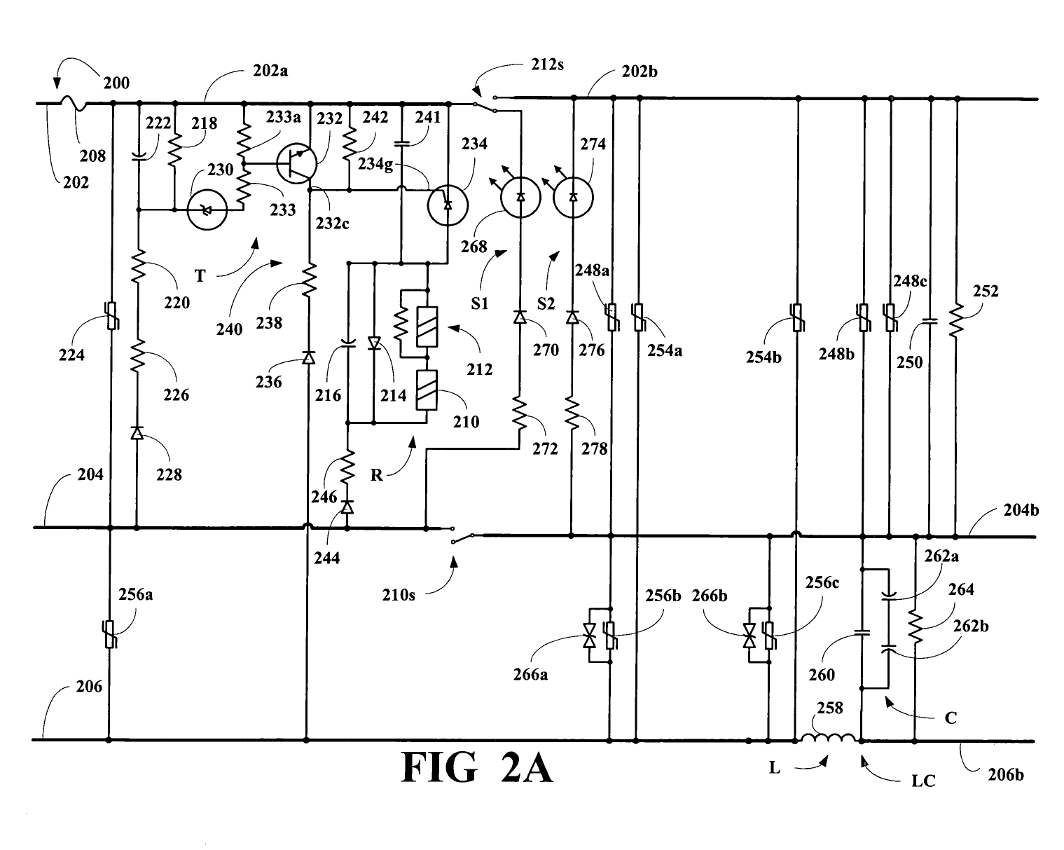

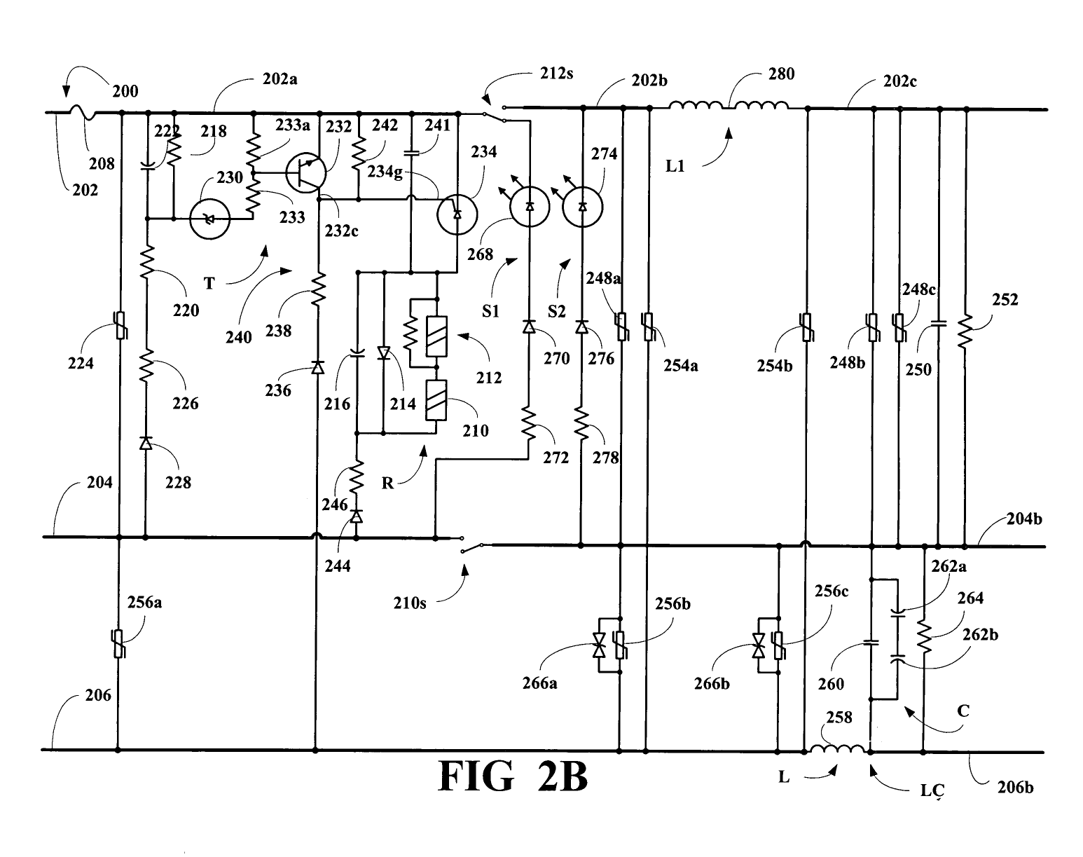

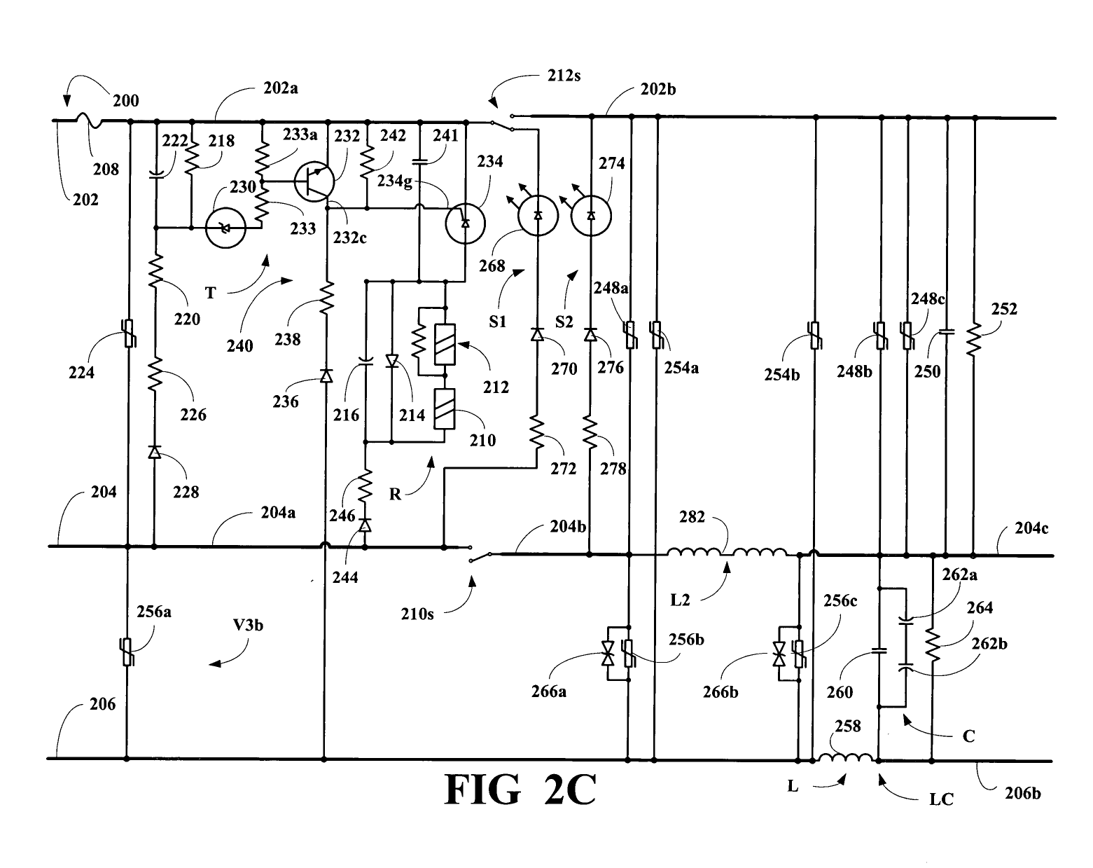

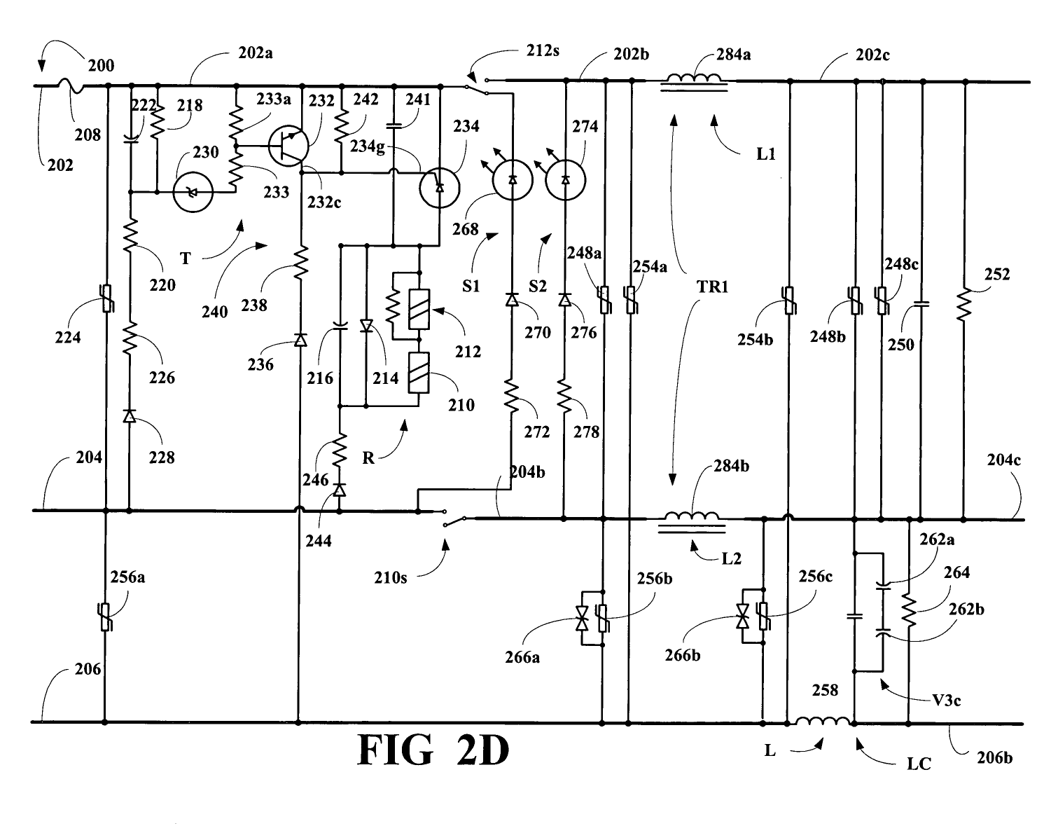

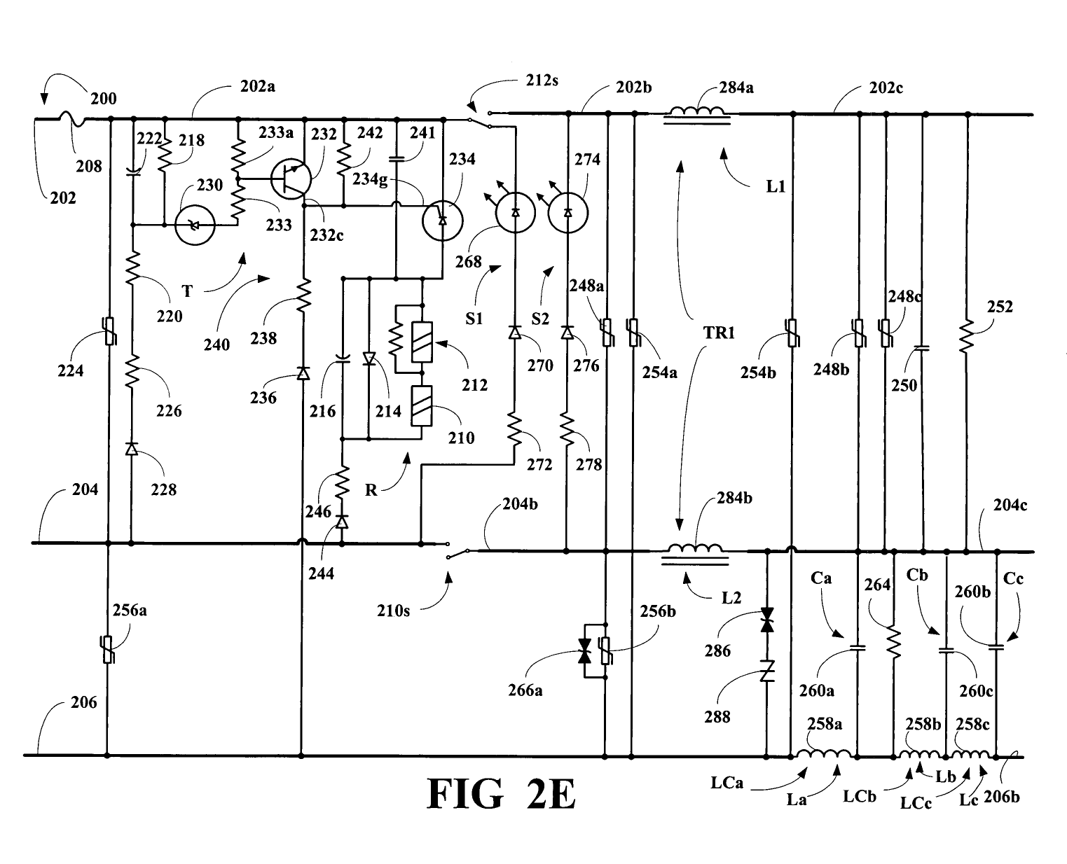

Referring now to FIG. 2A, a preferred embodiment of an apparatus of this invention, generally 200, is shown to include three leads, a hot lead 202, a neutral lead 204 and a ground lead 206. The three leads 202, 204 and 206 are designed to be connected to a single phase outlet of a power distribution network (not shown). The apparatus 200 may optionally include a protective fuse 208 for protecting components of the apparatus 200. The apparatus 200 includes at least one LC filter adapted to substantially reduce noise between the neutral and ground leads 204b and 206b, with an inductive component L 258 disposed between the ground lead 206 and 206b and a capacitive component C 260 between the neutral lead 204b and ground lead 206b after the inductive component L 258 toward the device as described more fully herein. The apparatus 200 can also includes voltage surge protection/filtration circuits between the hot and neutral leads 202 and 204, and/or between the hot and ground leads 202a and 206, and/or between the neural and ground leads 204 and 206, as described more fully herein. The apparatus 200 can also include noise reduction filters for reducing noise between the hot and neutral leads and/or between the hot and ground leads. The apparatus 200 can also includes a relay circuit R, a voltage threshold sensing circuit T and indicator circuits S1 and S2 for connecting or disconnecting components or leads in the apparatus 200 in response to an abnormal power condition.

Relay Circuit—R

The relay circuit R includes a first relay 210 and a second relay 212 connected between the hot lead 202a and neutral lead 204. As is conventional, a protective diode 214 and a filter capacitor 216 are connected in parallel across the relays 210 and 212. In the event of an abnormality in the power network, the switches of the relay circuit R are designed to disconnect the power going to the electrical device connected to the protective apparatus 200. In the event of an abnormality in the power network, the switches of the first relay 210 and second relay 212 also protect the voltage surge protection/filtration circuits against high voltages between any pair of the leads 202a, 204, and 206.

The first relay 210 controls a position or state of a first switch 210s. The switch 210s transitions between an opened state (as shown) and a closed state depending on current flow through the relay circuit R, where the closed state connects two parts 204 and 204b of the neutral lead. Thus, when the switch 210s is in its opened state, the utility part 204 of the neutral lead is disconnected from the lead 204b disrupting the continuity of the neutral lead 204. As long as the ground lead 206 is electrically connected to the utility ground, and also, as long as the connection between the hot and neutral leads 202 and 204 to the hot and neutral leads of the network is not reversed, and as long as the voltage of the power network is normal as sensed by the threshold sensing circuit T, then the relay 210 receives current and the switch 210s is in its closed position.

The second relay 212 of the relay circuit R includes controls a position or state of a second switch 212s. The switch 212s transitions between an opened state (as shown in FIG. 2A) and a closed state depending on current flow through the relay circuit R, where the closed state connects two parts 202a and 202b of the hot lead 202. Thus, when the switch 212s is in its opened state, the utility part 202a of the hot lead 202 is disconnected from the lead 202b disrupting the continuity of the hot lead 202. As long as the relay 212 is receiving electrical current, the switch 212s is closed and electrical power is furnished to the lead 202b of the hot lead 202. If no current flows through the relay 212, such as when the ground connection is interrupted, or polarity between the hot lead 202 and neutral lead 204 becomes reversed or an over voltage condition has occurred, the switch 212s opens and no power is furnished to the lead 202b of the hot lead 202 protecting the electronic device(s) connected to the apparatus 200 from voltage surges, over voltage or transients. The relays 210 and 212 also protect of apparatus circuit components against increased voltage.

Threshold Sensing Circuit T

The voltage threshold sensing circuit T is designed to detect when a voltage between the hot lead 202 and the neutral lead 204 from the distribution network exceeds a set or threshold voltage. The threshold voltage is established by a relative impedance of series connected resistors 218 and 220. The threshold voltage may be adjusted by selecting different impedance values for the two resistors 218 and 220, or by replacing either or both of the resistors 218 and 220 with variable resistors or rheostats. The sensing circuit T also includes a DC filter capacitor 222 connected in parallel with the resistor 218. The resistor 220 is electrically connected to the neutral lead 204 by a resistor 226 and a diode 228, which rectifies the AC voltage to DC.

A Zener diode 230 is electrically connected between the junction of the resistors 218 and 220 and the resistor 233 to sense the utility voltage. As long as the utility voltage does not exceed the threshold voltage, the Zener diode 230 does not conduct. If the utility voltage exceeds the threshold voltage, then the Zener diode 230 begins to conduct and a transistor or other electrical or electronic switch 232 with biasing resistors 233 and 233a begins to conduct. Obviously, the transistor 232 is normally held in a non-conductive state because the utility voltage is below the threshold voltage—the normal state.

A collector terminal 232c of the transistor 232 is connected to a thyristor 234 at a gate 234g, or other suitable electronic switch, such as a transistor, connected in series with the relays 210 and 212. When the transistor 232 begins to conduct due to the utility voltage exceeding the threshold voltage, the current through a diode 236 and resistor 238 to the gate 234g of the thyristor 234 is drawn to zero. The thyristor 234 is then switched to a non-conductor or off state and current flow through relays 210 and 212 is terminated. In this manner, the relays 210 and 212 become in the idle state and their switches 210s and 212s.

The thyristor 234 is normally biased to a conductive state and provides electrical current to relays 210 and 212 by a bias network 240 including an optional capacitor 241, the diode 236, the resistor 238 and another resistor 242. Another diode 244 rectifies the AC to DC and a resistor 246 limits the current in the relays 210 and 212, when the thyristor 234 is conductive and thus relays 210 and 212 are receiving current.

When the ground lead 206 and the hot and neutral leads 202 and 204 are properly connected to the power network, then a thyristor 234 is on. The relays 210 and 212 turn on setting the switches 210s and 212s to their closed positions connecting the neutral lead 204 to the neutral lead 204b and the hot lead 202a to the hot lead 202b. In this manner, any power surges or transients between the any pair of leads are suppressed by the voltage protection/filtration circuits described below.

Voltage Protection/Filtration Circuits

The hot-neutral voltage protection/filtration circuit includes a plurality of voltage clamping elements 224 and 248a-c, such as MOVs, gas tubes, Transils, Sidactors, or the like, connected between the hot lead 202a or 202b and the neutral leads 204 or 204b. The voltage protection/filtration circuit also includes a capacitor 250 and an optional discharge resistor 252.

The hot-ground voltage protection/filtration circuit includes a plurality of voltage clamping elements 254a-b connected between the hot lead 202b and the ground lead 206.

The neutral-ground voltage surge protection/filtration circuit includes a plurality of voltage clamping elements 256a-c connected between the neutral leads 204 and 204b and the ground lead 206. The neutral-ground voltage surge protection/filtration circuit also includes an LC filtering circuit LC including an inductive component L and a capacitive component C after the inductive component L. The inductive component L includes an inductor 258. The capacitive component C includes a main capacitor 260 or an optional pair of series connected capacitors 262a&b connected between the neutral lead 204b and the ground 206b and an optional discharging resistor 264. The neutral-ground voltage surge protection/filtration circuit can also include two optional Transils 266a-b attached parallel to the voltage clamping device 256b and 256c, respectively.

Although particular voltage clamping elements as described in the circuits above, any other voltage clamping element or combination of such elements can be used as well including, without limitation, MOVs, gas tubes, Transils, Sidactors, or the like.

Indicator Circuits S1 and S2

The first indicator circuit S1 is an alarm indicating circuit and includes a photo-emitter 268, such an LED, connected in series with the switch 212s to the hot lead 202a and also through an indicator circuit diode 270 and an indicator circuit resistor 272 to the neutral lead 204. The alarm photo-emitter 268 is energized when the switch 212s is in its opened position as shown in FIG. 2A and illuminates indicating the alarm condition.

The second indicator circuit S2 is a normal indicating circuit and includes a photo-emitter 274, such as an LED, connected between the hot lead 202b and through a second indicator circuit diode 276 and a second indicator circuit resistor 278 to the neutral lead 204b. During normal operation, when the relays 210 and 212 are receiving current, the switches 210s and 212s are in their closed positions and the normal photo-emitter 274 is energized and power flows through the apparatus 200 to the electrical devices attached thereto.

Referring now to FIG. 2B, another preferred embodiment of an apparatus of this invention, generally 200, is shown to include all the elements of FIG. 2A, with the addition of an inductive component L1 disposed in the hot lead 202b. In this embodiment, the inductive component L1 includes an inductor 280 connected in series in the hot lead between the hot leads 202b and 202c. The inductive component L1 in cooperation with the capacitor 250 and the resistor 252 forms a hot-neutral LC filter designed to substantially reduce noise between the hot lead 202c and the neutral lead 204b also the inductive component L1 in cooperation with the capacitors 250 and 260 and inductor 258 forms a hot-ground LC filter designed to substantially reduce noise between the hot lead 202c and the ground lead 206b.

Referring now to FIG. 2C, another preferred embodiment of an apparatus of this invention, generally 200, is shown to include all the elements of FIG. 2A, with the addition of an inductive component L2 disposed in the neutral lead 204b. In this embodiment, the inductive component L2 includes an inductor 282 connected in series in the neutral lead between the neutral leads 204b and 204c. The inductive component L2 in cooperation with the capacitor 250 and the resistor 252 forms an alternate hot-neutral LC filter designed to substantially reduce noise between the hot lead 202b and the neutral lead 204c.

Referring now to FIG. 2D, another preferred embodiment of an apparatus of this invention, generally 200, is shown to include all the elements of FIG. 2A, with the addition of a first winding of a transformer TR1 or single inductor 284a disposed in the hot lead between the hot leads 202b and 202c and a second winding of the transformer TR1 or a single inductor 284b disposed in the neutral lead between the neutral leads 204b and 204c. The two windings of the transformer TR1 can be positioned in series or differential.

Referring now to FIG. 2E, another preferred embodiment ofan apparatus of this invention, generally 200, is shown to include all the elements of FIG. 2A, with the addition of the transformer TR1 as described in FIG. 2D. Additionally, in this embodiment, the neutral-ground protection/filtration circuit includes a plurality of LC filter components LCa-c, each LC filter LCa-c including an inductive component La-c disposed in the ground lead and a capacitive component Ca-c positioned on the device side of its corresponding inductive component La-c and neutral lead 204b. Each inductive component La-c includes an inductor 258a-c and each capacitive component Ca-c includes a capacitor 260a-c. The neutral-ground protection/filtration circuit also includes an optional discharging resistor 264, which discharges the capacitors 260a-c. The neutral-ground protection/filtration circuit also includes a Transil 286 and a Sidactor 288 connected in series between the neural lead 204b and the ground lead 206 configured taking the place of a voltage clamping device.

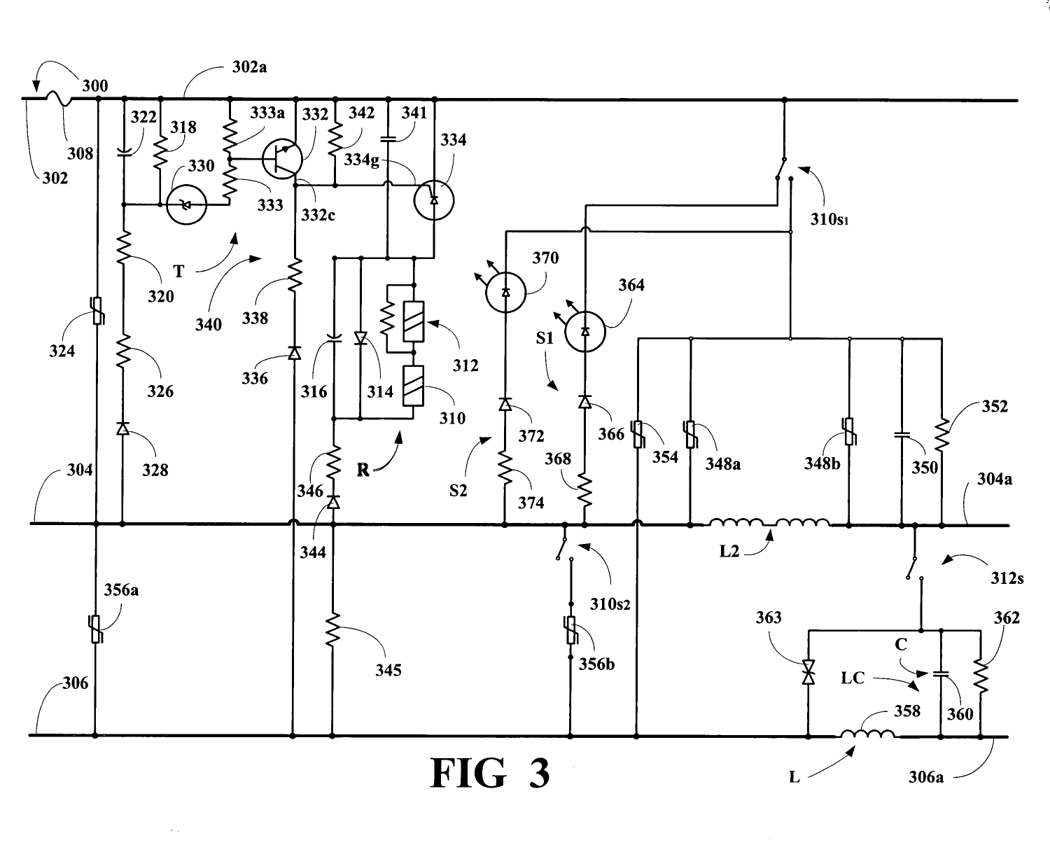

Referring now to FIG. 3, another preferred embodiment of an apparatus of this invention, generally 300, is shown to include three leads, a hot lead 302, a neutral lead 304 and a ground lead 306. The three leads 302, 304 and 306 are designed to be connected to a single phase outlet of a power distribution network (not shown). The apparatus 300 may optionally include a protective fuse 308 for protecting components of the apparatus 300. The apparatus 300 includes at least one LC filter adapted to substantially reduce noise between the neutral and ground leads 304a and 306a, with an inductive component L 358 disposed between the ground leads 306 and 306a and a capacitive component C 360 in series with the switch 212s is connected between the neutral lead 304a and ground lead 306a after the inductive component L 358 toward the device as described more fully herein also a resistor 362 and a clamping device 363 are parallel with the capacitor 360. The apparatus 300 can also include voltage surge protection/filtration circuits between the hot and neutral leads 302a and 304a, and/or between the hot and ground leads 302a and 306, and/or between the neural and ground leads 304 and 306, as described more fully herein. The apparatus 300 can also include noise reduction filters for reducing noise between the hot and neutral leads and/or between the hot and ground leads. The apparatus 300 also includes a relay circuit R, a voltage threshold sensing circuit T for connecting or disconnecting components in the apparatus 300 in response to an abnormal power condition, where the relay circuit R and the voltage threshold sensing circuit T are as described above, except that the element labels are analogous 300 series numbers and also the relay circuit R controls different switches with the relay 310 controlling two switches. The apparatus 300 includes indicator circuits S1 and S2, where the indictor circuits S1 and S2 as described above, except that the element labels are again analogous 300 series numbers.

Voltage Protection/Filtration Circuits

The hot-neutral voltage protection/filtration circuit includes one voltage clamping elements 324 between the hot lead 302a and neutral lead 304, also a plurality of voltage clamping devices 348a-b such as MOVs, gas tubes, Transils, Sidactors, or the like, in series with the switch 310s1 are connected between the hot lead 302a and the neutral leads 304 or 304a. The voltage protection/filtration circuit also includes a capacitor 350 and a discharge resistor 352 parallel with the voltage clamping device 348a&b.

The hot-ground voltage protection/filtration circuit includes a voltage clamping elements 354 in series with the switch 310s1 connected between the hot lead 302a and the ground lead 306.

The neutral-ground voltage surge protection/filtration circuit includes a plurality of voltage clamping elements 356a connected between the neutral leads 304 and the ground lead 306 and also includes a voltage clamping 356b in series with the switch 310s2 connected between the neutral lead 304 and the ground lead 306. The neutral-ground voltage surge protection/filtration circuit also includes an LC filtering circuit LC including an inductive component L disposed between the ground leads 306 and 306a, a capacitive component C in series with the switch 312s connected between the neutral and ground leads 304a and 306a after the inductive component L. The inductive component L includes an inductor 358. The capacitive component C includes a capacitor 360 and an optional discharging resistor 362 in parallel with the capacitor 360 also include a Transil 363 or a combination of a Transil in series with a Sidactor in parallel with the capacitor 360. As shown in FIG. 3, the capacitive component C of the LC filter of the neutral-ground protection/filtration circuit disconnected (inactive) when the switch 312s is opened due to an abnormal condition in order to limit the flow of current to the ground 306 and connected (active) when the switch 312s is closed.

It should be noted that each of the various voltage clamping devices, as well as the electrical filter elements, such as capacitors and inductors, in the apparatuses of this invention are connected between the neutral lead and the ground lead, between hot and ground and between neutral and ground. In this manner, an undesirable effect, such as neutral-ground (or common mode) noise, hot-neutral noise and hot-ground noise and transient spikes are filtered and suppressed by the protection/filtration apparatus components.

It should be understood also that the relays and may be separately connected individually between the utility parts of the hot lead and neutral lead, respectively, rather than in series as shown in the Figures. In this separate connection format, each of the relays are provided with a separate thyristor or other electronic switch functioning like the thyristor. Each such separate thyristor or electronic switch is of course provided with its own corresponding bias network of the type described above. Also, if desired, one relay with two sets of switch arm contacts may be used as an alternate. Moreover, the protection/filtration circuits of this invention can be constructed in a number of different configuration and still include an LC filter circuit between the neutral and ground leads with the inductor in the ground lead.

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that may be made which do not depart from the scope and spirit of the invention as described above and claimed hereafter.

1. A protective circuit having hot, neutral, and ground leads arranged to be placed between corresponding utility hot, neutral, and ground leads of a power utility outlet of a multi-phase power distribution network and corresponding device hot, neutral, and ground leads of at least one electrical and/or electronic device, the protective circuit comprising:
a neutral-ground voltage surge protection/filtration circuit including at least one LC filter circuit component having at least one inductive component disposed in the circuit ground lead, at least one capacitor connected between the circuit neutral and circuit ground leads after the inductor towards the device, where the at least one the LC filter circuit component is adapted to reduce or eliminate ground noise or noise between ground and neutral leads transmitted to the devices.

2. The protective circuit of claim 1, further comprising:
a first relay controlling at least one first switch,
where the at least one first switch is in an opened condition when no current is flowing through the first relay corresponding to an abnormal state of the circuit disconnecting some or all of components of the neutral-ground voltage surge protection/filtration circuit and
where the first switch is in a closed condition when current is flowing through the first relay corresponding to a normal state of the circuit connecting the neutral-ground voltage surge protection/filtration circuit component.

3. The protective circuit of claim 2, wherein when the at least one first switch is in its opened condition, then the utility part of the neutral lead is disconnected from the device part of the neutral lead protecting the device and when the at least one first switch is in its closed condition the utility part of the neutral lead is connected to the device part of the neutral lead activating the device.

4. The protective circuit of claim 1, further comprising:
a hot-neutral voltage surge protection/filtration circuit component adapted to substantially reduce noise between the hot and neutral ends and to clamp a voltage between the leads, and
a hot-ground voltage surge protection circuit component adapted to substantially reduce noise between the hot and ground ends and to clamp a voltage between the leads.

5. The protective circuit of claim 4, further comprising:
a first relay controlling at least one first switch,
where the at least one first switch is in an opened condition when no current is flowing through the first relay corresponding to an abnormal state of the circuit disconnecting some or all of components of the neutral-ground voltage surge protection/filtration circuit and
where the first switch is in a closed condition when current is flowing through the first relay corresponding to a normal state of the circuit connecting the neutral-ground voltage surge protection/filtration circuit component;
a second relay controlling a second switch,
where the second switch is in an opened condition when no current is flowing through the second relay corresponding to an abnormal state of the circuit causing the second switch to disconnect the hot-neutral voltage surge protection circuit component and the hot-ground voltage surge protection circuit component and
where the second switch is in a closed condition when current is flowing through the second relay corresponding to a normal state of the circuit causing the second switch to connect the hot-neutral voltage surge protection circuit component and the hot-ground voltage surge protection circuit component.

6. The protective circuit of claim 5, wherein when the first switch is in its opened condition, then the utility part of the neutral lead is disconnected from the device part of the neutral lead protecting the device and when the first switch is in its closed condition the utility part of the neutral lead is connected to the device part of the neutral lead activating the device.

7. The protective circuit of claim 5, wherein when the second switch is in its opened condition, a utility part of the hot lead is disconnected from a device part of the hot lead protecting the device and when the second switch is in its closed condition, then the utility part of the hot lead is connected to the device part of the hot lead.

8. The protective circuit of claim 5, wherein:
when the first switch is in its opened condition, then the utility part of the neutral lead is disconnected from the device part of the neutral lead protecting the device;
when the first switch is in its closed condition the utility part of the neutral lead is connected to the device part of the neutral lead activating the device;
when the second switch is in its opened condition, a utility part of the hot lead is disconnected from a device part of the hot lead protecting the device; and
when the second switch is in its closed condition, then the utility part of the hot lead is connected to the device part of the hot lead.

9. The protective circuit of claim 5, further comprising:
a voltage threshold sensing circuit adapted to detect when the voltage on the circuit hot lead exceeds a threshold value;
a relay supply switch for providing current to the relay circuit; and
an electronic switch responsive to the voltage threshold sensing circuit for disabling the relay supply switch allowing the relays to transition between their closed and opened conditions.

10. The protective circuit of claim 5, further comprising:
a voltage threshold sensing circuit adapted to detect when the voltage between the circuit hot and neutral leads exceeds a threshold value,
a relay supply switch for providing current to the relay circuit; and
an electronic switch responsive to the voltage threshold sensing circuit for disabling the relay supply switch allowing the relays to transition between their closed and opened conditions.

11. The protective circuit of claim 5, further comprising:
a voltage threshold sensing circuit adapted to detect when the voltage on the circuit hot lead exceeds a threshold value;
a relay supply switch for providing current to the relay circuit;
an electronic switch responsive to the voltage threshold sensing circuit for disabling the relay supply allowing the relays to transition between their closed and opened conditions when a connection between ground leads is disconnected.

12. The protective circuit of claim 5, further comprising:
a voltage threshold sensing circuit adapted to detect when the voltage on the circuit hot lead exceeds a threshold value;
a relay supply switch for providing current to the relay circuit;
an electronic switch responsive to the voltage threshold sensing circuit for disabling the relay supply allowing the relays to transition between their closed and opened conditions when the connection between the hot and neutral lead is reversed.

13. The protective circuit of claim 1, further comprising:
a first indicator circuit for indicating a normal state, and a second indicator circuit for indicating an abnormal state.

14. The protective circuit of claim 1, wherein the neutral-ground voltage surge protection/filtration circuit component includes a resistor and a plurality of LC filter circuit component, each LC filter circuit including at least one inductor disposed in the circuit ground lead and at least one capacitor connected between the circuit neutral and circuit ground leads after the inductor toward the device, where the LC filter circuits is adapted to reduce or eliminate ground noise or noise between ground and neutral leads transmitted to the devices.

15. A protective circuit having hot, neutral, and ground leads arranged to be placed between corresponding utility hot, neutral, and ground leads of a power utility outlet of a power distribution network and corresponding device hot, neutral, and ground leads of electrical and/or electronic devices, the protection/filtration circuit comprising:
a hot-neutral voltage surge protection circuit component connected between the circuit hot and neutral leads,
a hot-ground voltage surge protection circuit component connected between the circuit hot and ground leads; and
a neutral-ground voltage surge protection/filtration circuit component connected between the circuit neutral and circuit ground leads including at least one LC filter circuit component having at least one inductor disposed in the circuit ground lead, at least one capacitor connected between the circuit neutral and circuit ground leads after the inductor and a resistor adapted to discharge the capacitor, where the at least one the LC filter circuit component is adapted to reduce or eliminate ground noise or noise between ground and neutral leads transmitted to the devices and to reduce or eliminate ground leakage currents.

16. The protective circuit of claim 15, further comprising:
a first relay controlling at least one first switch,
where the at least one first switch is in an opened condition when no current is flowing through the first relay corresponding to an abnormal state of the circuit disconnecting some or all of components of the neutral-ground voltage surge protection/filtration circuit and
where the first switch is in a closed condition when current is flowing through the first relay corresponding to a normal state of the circuit connecting the neutral-ground voltage surge protection/filtration circuit component.

17. The protective circuit of claim 16, wherein when the first switch is in its opened condition, then the utility part of the neutral lead is disconnected from the device part of the neutral lead protecting the device and when the first switch is in its closed condition the utility part of the neutral lead is connected to the device part of the neutral lead activating the device.

18. The protective circuit of claim 15, further comprising:
a first relay controlling a first switch,
a first relay controlling at least one first switch,
where the at least one first switch is in an opened condition when no current is flowing through the first relay corresponding to an abnormal state of the circuit disconnecting some or all of components of the neutral-ground voltage surge protection/filtration circuit and
where the first switch is in a closed condition when current is flowing through the first relay corresponding to a normal state of the circuit connecting the neutral-ground voltage surge protection/filtration circuit component; a second relay controlling a second switch,
where the second switch is in an opened condition when no current is flowing through the second relay corresponding to an abnormal state of the circuit causing the second switch to disconnect the hot-neutral voltage surge protection circuit component and the hot-ground voltage surge protection circuit component and
where the second switch is in a closed condition when current is flowing through the second relay corresponding to a normal state of the circuit causing the second switch to connect the hot-neutral voltage surge protection circuit component and the hot-ground voltage surge protection circuit component.

19. The protective circuit of claim 18, wherein when the first switch is in its opened condition, then the utility part of the neutral lead is disconnected from the device part of the neutral lead protecting the device and when the first switch is in its closed condition the utility part of the neutral lead is connected to the device part of the neutral lead activating the device.

20. The protective circuit of claim 18, wherein when the second switch is in its opened condition, a utility part of the hot lead is disconnected from a device part of the hot lead protecting the device and when the second switch is in its closed condition, then the utility part of the hot lead is connected to the device part of the hot lead.

21. The protective circuit of claim 18, wherein:
when the first switch is in its opened condition, then the utility part of the neutral lead is disconnected from the device part of the neutral lead protecting the device;
when the first switch is in its closed condition the utility part of the neutral lead is connected to the device part of the neutral lead activating the device;
when the second switch is in its opened condition, a utility part of the hot lead is disconnected from a device part of the hot lead protecting the device; and
when the second switch is in its closed condition, then the utility part of the hot lead is connected to the device part of the hot lead.

22. The protective circuit of claim 18, further comprising:
a voltage threshold sensing circuit adapted to detect when the voltage on the circuit hot lead exceeds a threshold value;
a relay supply switch for providing current to the relay circuit; and
an electronic switch responsive to the voltage threshold sensing circuit for disabling the relay supply switch allowing the relays to transition between their closed and opened conditions.

23. The protective circuit of claim 18, further comprising:
a voltage threshold sensing circuit adapted to detect when the voltage between the circuit hot and neutral leads exceeds a threshold value,
a relay supply switch for providing current to the relay circuit; and
an electronic switch responsive to the voltage threshold sensing circuit for disabling the relay supply switch allowing the relays to transition between their closed and opened conditions.

24. The protective circuit of claim 18, further comprising:
a voltage threshold sensing circuit adapted to detect when the voltage on the circuit hot lead exceeds a threshold value;
a relay supply switch for providing current to the relay circuit;
an electronic switch responsive to the voltage threshold sensing circuit for disabling the relay supply allowing the relays to transition between their closed and opened conditions when a connection between ground leads is disconnected.

25. The protective circuit of claim 18, further comprising:
a voltage threshold sensing circuit adapted to detect when the voltage on the circuit hot lead exceeds a threshold value;
a relay supply switch for providing current to the relay circuit;
an electronic switch responsive to the voltage threshold sensing circuit for disabling the relay supply allowing the relays to transition between their closed and opened conditions when the connection between the hot and neutral lead is reversed.

26. The protective circuit of claim 15, further comprising:
a first indicator circuit for indicating a normal state, and
a second indicator circuit for indicating an abnormal state.

27. The protective circuit of claim 15, wherein the neutral-ground voltage surge protection/filtration circuit component includes a resistor and a plurality of LC filter circuit component, each LC filter circuit including at least one inductor disposed in the circuit ground lead and at least one capacitor connected between the circuit neutral and circuit ground leads after the inductor, where the LC filter circuits is adapted to reduce or eliminate ground noise or noise between ground and neutral leads transmitted to the devices and to reduce or eliminate ground leakage currents.

28. A protective circuit having hot, neutral, and ground leads arranged to be placed between corresponding utility hot, neutral, and ground leads of a power utility outlet of a power distribution network and corresponding device hot, neutral, and ground leads of electrical and/or electronic devices, the protection/filtration circuit comprising:
a hot-neutral voltage surge protection circuit component connected between the circuit hot and neutral leads,
a hot-ground voltage surge protection circuit component connected between the circuit hot and ground leads;
a neutral-ground voltage surge protection/filtration circuit component connected between the circuit neutral and circuit ground leads including at least one LC filter circuit component having at least one inductor disposed in the circuit ground lead, at least one capacitor connected between the circuit neutral and circuit ground leads after the inductor and a resistor adapted to discharge the capacitor, where the at least one the LC filter circuit component is adapted to reduce or eliminate ground noise or noise between ground and neutral leads transmitted to the devices and to reduce or eliminate ground leakage currents;
a first relay controlling at least one first switch,
where the at least one first switch is in an opened condition when no current is flowing through the first relay corresponding to an abnormal state of the circuit disconnecting some or all of components of the neutral-ground voltage surge protection/filtration circuit and
where the first switch is in a closed condition when current is flowing through the first relay corresponding to a normal state of the circuit connecting the neutral-ground voltage surge protection/filtration circuit component; and
a second relay controlling a second switch,
where the second switch is in an opened condition when no current is flowing through the second relay corresponding to an abnormal state of the circuit causing the second switch to disconnect the hot-neutral voltage surge protection circuit component and the hot-ground voltage surge protection circuit component, and
where the second switch is in a closed condition when current is flowing through the second relay corresponding to a normal state of the circuit causing the second switch to connect the hot-neutral voltage surge protection circuit component and the hot-ground voltage surge protection circuit component.

29. The protective circuit of claim 28, further comprising:
a voltage threshold sensing circuit adapted to detect when the voltage on the circuit hot lead exceeds a threshold value;
a relay supply switch for providing current to the relay circuit; and
an electronic switch responsive to the voltage threshold sensing circuit for disabling the relay supply switch allowing the relays to transition between their closed and opened conditions.

30. The protective circuit of claim 28, further comprising:
a voltage threshold sensing circuit adapted to detect when the voltage between the circuit hot and neutral leads exceeds a threshold value,
a relay supply switch for providing current to the relay circuit; and
an electronic switch responsive to the voltage threshold sensing circuit for disabling the relay supply switch allowing the relays to transition between their closed and opened conditions.

31. The protective circuit of claim 28, further comprising:
a voltage threshold sensing circuit adapted to detect when the voltage on the circuit hot lead exceeds a threshold value;
a relay supply switch for providing current to the relay circuit;
an electronic switch responsive to the voltage threshold sensing circuit for disabling the relay supply allowing the relays to transition between their closed and opened conditions when a connection between ground leads is disconnected.

32. The protective circuit of claim 28, further comprising:
a voltage threshold sensing circuit adapted to detect when the voltage on the circuit hot lead exceeds a threshold value;
a relay supply switch for providing current to the relay circuit;
an electronic switch responsive to the voltage threshold sensing circuit for disabling the relay supply allowing the relays to transition between their closed and opened conditions when the connection between the hot and neutral lead is reversed.

33. The protective circuit of claim 28, further comprising:
a first indicator circuit for indicating a normal state, and a second indicator circuit for indicating an abnormal state.

34. The protective circuit of claim 28, wherein the neutral-ground voltage surge protection/filtration circuit component includes a resistor and a plurality of LC filter circuit component, each LC filter circuit including at least one inductor disposed in the circuit ground lead and at least one capacitor connected between the circuit neutral and circuit ground leads after the inductor, where the LC filter circuits is adapted to reduce or eliminate ground noise or noise between ground and neutral leads transmitted to the devices and to reduce or eliminate ground leakage currents.
